(19) United States
(12) Patent Application Publication
(10) Pub. No.: US 2008/0004390 A1
(43) Pub. Date: Jan. 3, 2008

(54) ORGANIC-INORGANIC HYBRID MATERIAL, METHOD OF PRODUCING THE SAME, AND SUPERHYDROPHILIC MATERIAL

(75) Inventors: Toshihide Aoshima, Ashigarakami-gun (JP); Koichi Kawamura, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/769,838

(22) Filed: Jun. 28, 2007

(30) Foreign Application Priority Data
Jun. 30, 2006 (JP) 2006-182289

(51) Int. Cl. C08K 3/22; B60C 1/00; C08K 3/04

(52) U.S. Cl. 524/430; 524/492; 524/495

(57) ABSTRACT

The invention provides an organic-inorganic hybrid material comprising a support, and an organic-inorganic composite layer having a surface having protrusions and depressions a containing a crosslinked structure formed by hydrolysis and polycondensation of an alkoxide of an element selected from the group consisting of Si, Ti, Zr, and Al, the organic-inorganic composite layer being provided within a graft polymer layer comprising a graft polymer chain that is bonded directly to a surface of the support.

### CROSS REFERENCES TO RELATED APPLICATIONS

This invention claims priority under 35 USC 119 from Japanese Patent Application No. 2006-182289, the disclosure of which is incorporated by reference herein.

### BACKGROUND OF THE INVENTION

1. Field of the Invention

The present invention relate to an organic-inorganic hybrid material, a method of producing the same, and a superhydrophilic material using the organic-inorganic hybrid material.

2. Description of the Related Art

Since organic polymeric materials are light in weight, soft and flexible, and excellent in insulation property and moldability, they have a wide range of application uses but involve drawbacks such as poor corrosion resistance and heat resistance. On the other hand, inorganic materials have excellent corrosion resistance and heat resistance, and attempt of mixing them to prepare materials not found so far having respective advantages of them in combination.

Further, it has also been studied vigorously to mix different kinds of polymeric compounds or making them compatible by using compatibilizing agents to form polymer alloys thereby providing new functions.

On the other hand, it has been generally conducted to manufacture functional films by providing layers comprising various inorganic materials, for example, conductive materials, hard coat materials, light recording materials, and photocatalytic active materials on plastic substrates. In a case of providing such inorganic materials on the plastic substrates, since adhesion with the substrate is generally insufficient, it is generally practiced to provide an adhesive layer on a plastic substrate and dispose an inorganic material layer thereon. However, the method involves a problem, for example, that adhesion between the plastic substrate and the adhesive layer or between the adhesive layer and the inorganic material is not always sufficient to sometimes result in a problem of lowering the adhesion property with time. Accordingly, it has been highly demanded for the development of a technique of forming an inorganic material with good adhesion on a plastic substrate.

Meanwhile, it has been studied vigorously in recent years to provide the surface of glass, ceramics, metals, and organic polymeric materials with water repellency and hydrophilicity. While the wetting property of a solid surface undergoes the effect of the chemical property on the surface and the surface shape, a superhydrophilic surface at a contact angle with water of 100 or less or a superwater repellent surface with an contact angle with water of 150° or more can not be attained only by means of the chemical property and it has been known that it is necessary to improve the hydrophilicity or water repellency of the substrate surface by providing the surface with a structure of protrusions and depressions (refer, for example, to R. N. Wenzel, J. Phys. Colloid Chem. 1949, 53, 1466, A. B. D. Cassie, Discuss, Farady Soc. 1948, 3, 11, and R. E. Johnson Jr and R. H. Dettre. Adv. Chem. Ser. 1963, 43, 112.1 to 3).

For providing the structure of protrusions and depressions, an etching method is used, for example, but there is a problem in this case that the substrate per se is deteriorated.

Further, a method of forming a hydrophilic, antifogging and antifouling thin film having a structure of protrusions and depressions on the surface by forming a thin metal oxide film has been disclosed (refer, for example, to JP-A No. 2004-2104). While the method is suitable to the treatment for the surface of a glass substrate, in a case where the thin metal oxide film is formed to the surface of an organic substrate, adhesion at the organic-inorganic boundary is low and development of a new technique has been necessary for improving the adhesion.

### SUMMARY OF THE INVENTION

The invention has been made in view of the above circumstances and provides an organic-inorganic hybrid material, a method of producing the same and a superhydrophilic material.

A first aspect of the invention provides an organic-inorganic hybrid material including a support, and an organic-inorganic composite layer containing a crosslinked structure formed by hydrolysis and polycondensation of an alkoxide of an element selected from the group consisting of Si, Ti, Zr, and Al in a graft polymer layer comprising a graft polymer chain bonded directly to a surface of the support, and having a surface.

### DETAILED DESCRIPTION OF THE INVENTION

In view of the problems in the related art described above, the present invention intends to provide an organic-inorganic hybrid material having a surface having protrusions and depressions excellent in the adhesion to a support and a method of producing the same.

The invention further intends to provide a superhydrophilic material having superhydrophlicity and retainability thereof by using the organic-inorganic hybrid material.

The present inventors has made an earnest study on an organic-inorganic composite layer containing a graft polymer chain bonded directly on a support and a crosslinked structure formed by hydrolysis and polycondensation of a metal alkoxide and, as a result, have found that the foregoing subject can be solved by making a surface of the organic-inorganic composite layer to a shape of protruded and depressed shape, and have accomplished the present invention.

That is, the organic-inorganic hybrid material according to the invention includes a support, and a crosslinked structure formed by hydrolysis and polycondensation of an alkoxide of an element selected from the group consisting of Si, Ti, Zr, and Al in a graft polymer layer comprising a graft polymer chain bonded directly to a support surface, and an organic-inorganic composite layer having a surface having protrusions and depressions.

In the invention, it is preferred that an arithmetic average roughness (Ra) on the surface having protrusions and depressions is preferably 0.03 μm or more and/or a specific surface area is preferably 1.2 or more.

Further, in a preferred embodiment, a height of protrusion parts in the protrusion and depression surface is from 0.1 to 5 μm.

Furthermore, the superhydrophilic material of the invention can be attained by using an organic-inorganic hybrid material of the invention.

The graft polymer chain described above is preferably formed by polymerization reaction starting from initiation species generated on the surface of the support.

Further, the graft polymer chain preferably has alkoxide group and/or amide group of an element selected from the group consisting of Si, Ti, Zr, and Al in the chain.

The graft polymer chain is preferably a copolymer of a structural unit having a polar group, preferably, an amide group and a structural unit having an alkoxide group of an element selected from the group consisting of Si, Ti, Zr, and Al such as a silane coupling group.

In addition, in a case of applying the organic-inorganic hybrid material to a superhydrophilic material, the graft polymer chain preferably has a hydrophilic group as a sort of polar groups.

Further, the method for producing the organic-inorganic hybrid material according to the invention includes a process of forming a graft polymer chain bonded directly to the surface of a support and forming a graft polymer layer comprising the graft polymer chain and a process of providing fine inorganic particles with a volume average grain size of 1 μm or more in the graft polymer layer, further, conducting crosslinking reaction in the graft polymer layer by hydrolysis and polycondensation of an alkoxide of an element selected from the group consisting of Si, Ti, Zr, and Al and forming an organic-inorganic composite layer having a surface having protrusions and depressions.

While the action mechanism of the invention is not apparent, it is estimated as described below.

The organic-inorganic composite layer having a surface having protrusions and depressions in the invention comprises a graft polymer chain (organic ingredient) bonded directly to a surface of a support and a crosslinked structure (inorganic ingredient) formed in the graft polymer layer comprising the graft polymer chain formed by hydrolysis and polycondensation of an alkoxide of an element selected from the group consisting of Si, Ti, Zr, and Al. Since such an organic-inorganic composite layer increases the wear resistance and has high durability even it is a thin layer, the protrusion and depression surface as the surface thereof is excellent in adhesion with the support.

Particularly, in a case where the graft polymer chain has a polar group, a polar interaction is formed by the function of the polar group relative to the crosslinked structure and an organic-inorganic composite layer of excellent strength and durability can be formed. Further, in a case where the graft polymer chain has an alkoxide group of an element selected from the group consisting of Si, Ti, Zr, and Al in the chain, a covalent bond is formed between the graft polymer chain and the crosslinked structure to improve the strength and the durability of the organic-inorganic composite layer.

Further, in a case where the organic-inorganic composite layer shows a hydrophilicity, it is considered that since the surface has a shape of protrusions and depressions, the hydrophilicity is further improved to exhibit a superhydrophilicity. As a result, a superhydrophilic material having the superhydrophilicity and the retainability thereof can be obtained by using the organic-inorganic hybrid material of the invention.

The present invention is to be described specifically.

The organic-inorganic hybrid material according to the invention includes a support, and a crosslinked structure formed by hydrolysis and polycondensation of an alkoxide of an element selected from the group consisting of Si, Ti, Zr, and Al in a graft polymer layer comprising a graft polymer chain bonded directly to the support surface and has an organic-inorganic composite layer having a surface having protrusions and depressions.

That is, organic-inorganic hybrid material of the invention is a material having a support and an organic-inorganic composite layer having a surface having protrusions and depressions.

In the invention, “organic-inorganic composite layer having a surface having protrusions and depressions” means an organic-inorganic composite layer having a surface with a maximum difference in a height of 0.1 μm or more.

In the organic-inorganic hybrid material of the invention, it is preferred that the crosslinked structure is formed by using an Si alkoxide with a with view point of reactivity and easy availability of compounds.

The crosslinked structure formed by hydrolysis and polycondensation of the alkoxide described above is hereinafter referred to sometime as “sol-gel crosslinked structure” in the invention.

In the organic-inorganic hybrid material of the invention, an arithmetic average roughness (Ra) on the surface having protrusions and depressions is, preferably, 0.03 μm or more, more preferably, 0.033 μm or more and, further preferably, 0.035 μm or more. Further, in view of the durability of the surface having protrusions and depressions, the upper limit value for the arithmetic average roughness (Ra) is preferably 1.0 μm.

The arithmetic average roughness (Ra) is measured according to the method described in JIS B 0601-1994.

Further, in the organic-inorganic hybrid material of the invention, a specific surface area of the surface having protrusions and depressions is, preferably, 1.2 or more, more preferably, 1.25 or more and, further preferably, 1.3 or more. With the view point of the durability of the surface having protrusions and depressions, the upper limit value for the specific surface area is preferably 2.

The specific surface area is measured by a simple AFM (nanopics, manufactured by Seiko Instruments Co.).

Further, in the organic-inorganic hybrid material of the invention, a height for the protrusion portion at the protrusion and depression surface is, preferably, from 0.1 to 5 μm, more preferably, from 0.1 to 4.5 μm and, further preferably, from 0.1 to 4.0 μm.

The height for the protrusion portion at the surface of the organic-inorganic composite layer in the invention means the maximum difference for the height within the plane for measurement.

The height for the protrusion portion is measured by a simple AFM (nanopics, manufactured by Seiko Instruments Co.).

The organic-inorganic hybrid material of the invention is applicable, for example, to superhydrophilic materials, antireflection films, antistatic films, etc. Among them, it is applied preferably to superhydrophilic materials with a view point that the material surface has a high wetting property.

In the invention, “superhydrophilicity” means that the contact angle with water is 10° or less, and means that the contact angle with water on the surface having protrusions and depressions is 10° or less in the super hydrophilic material of the invention using the organic-inorganic hybrid material of the invention.

The contact angle with water can be measured by CA-Z manufactured by Kyowa Interface Science Co., LTD.

The organic-inorganic hybrid material of the invention described above is preferably produced by the method for producing the organic-inorganic hybrid material of the invention described below.

That is, for the method for producing the organic-inorganic hybrid material of the invention, it is preferred to apply a method including forming a graft polymer chain bonded directly to a surface of a support and forming a graft polymer layer comprising the graft polymer chain (hereinafter sometimes referred to as “process of forming a graft polymer layer”) and a process of providing fine inorganic particles with a volume average grain size of 1 μm or more in the graft polymer layer and, further, conducting crosslinking reaction in the graft polymer layer by hydrolysis and polycondensation of an alkoxide of an element selected from the group consisting of Si, Ti, Zr, and Al and forming an organic-inorganic composite layer having a surface having protrusions and depressions (hereinafter sometimes referred to as “process of forming organic-inorganic composite layer having a surface having protrusions and depressions”.

“graft polymer layer forming process” and “process of forming organic-inorganic composite layer having a surface having protrusions and depressions” are to be described sequentially. In the description for each of the process, preferred embodiments of applying the organic-inorganic hybrid material to the superhydrophilic material of the invention is to be described together.

<Graft Polymer Layer Forming Process>

In this process, a graft polymer chain bonded directly to the surface of a support is formed and a graft polymer layer comprising the graft polymer chain is formed.

The method of forming a graft polymer chain directly bonded to the surface of the support includes (1) a method of putting a compound having a polymerizable double bond to surface graft polymerization with the support as a trigger point to form a graft polymer chain and (2) a method of chemically bonding a polymer having a functional group reactive with the support and the surface of the support thereby forming a graft polymer chain.

Two methods are to be described below.

(1) A method of putting a compound having a polymerizable double bond to surface graft polymerization with the support being as a trigger point thereby forming a graft polymer chain.

The method is generally referred to as a surface graft polymerization. The surface graft polymerization method is a method of giving active species on the surface of a support by a method such as plasma irradiation, photoirradiation, or heating and polymerizing a compound having a polymerizable double bond disposed so as to be in contact with a support with the active species being as a trigger point. According to the method, the terminal end of the formed graft polymer chain is directly coupled and fixed to the surface of the support.

As the surface graft polymerization method for practicing the invention, any of known methods described in the literatures can be used. For example, a photograft polymerization method and a plasma irradiated graft polymerization method are described as the surface graft polymerization method, New Polymer Experimental Science 10, p 135, edited by the Society of Polymer Science in Japan, published from Kyoritsu Shuppan Co., 1994. Further, an irradiation-induced graft polymerization method by radiation rays such as γ-rays and electron beams is described in Adsorption Technology Manual, p 203, p 695 edited by Takeuchi NTS Co., published, 1999. 2. For the specific method of photo graft polymerization, methods described in JP-A Nos. 63-92658, 10-296895 and 11-119413 can be used. In the plasma-irradiated graft polymerization method and the irradiation-induced graft polymerization method, those methods described, for example, in the literatures described above and Macromolecules vol. 19, page 1804 (1986) by Y. Ikada et al can be applied.

Specifically, graft polymer chains can be formed by treating the surface of a polymer such as PET with plasmas or electron beams to generate radicals as active species on the surface and then reacting the surface of the support having the active species and a compound (for example, monomer) having a polymerizable double bond.

The photograft polymerization can also be conducted by coating a photopolymerizable composition on the surface of a film support, and irradiating light under contact with a radical polymerization compound as described in JP-A No. 53-17407 (Kansai Paint Co.) or JP-A No. 2000-212313 (Dai Nippon Ink Co.) in addition to the literatures described above.

It is necessary that the compound useful upon forming the graft polymer chain by the method (1) has a polymerizable double bond. Further, it is preferably a compound having the polymerizable double bond and having a polar group considering the forming property of the polar interaction with a sol-gel crosslinked structure formed in the process of forming an organic-inorganic composite layer to be described later. Further, it is preferably a compound having the polymerizable double bond and having an alkoxide group of a specified element considering the formation of a covalent bond relative to the sol-gel crosslinked structure formed in the process of forming the organic-inorganic composite layer to be described later.

Further, in a case of applying the organic-inorganic hybrid material to be produced to a superhydrophilic material, it preferably has hydrophilic groups in the graft polymer chain. For this purpose, it is preferred in the method (1) to use a compound having a double bond and having a hydrophilic group as a sort of a polar group in the molecule.

As the compound applied to the method, any of polymer, oligomer or monomer of the compound can be used so long as it has a double bond in the molecular and, optionally, has a polar group and/or an alkoxide group of a specified element.

One of useful compounds in the invention is a monomer having a polar group (hydrophilic group).

The monomer having the polar group (hydrophilic group) useful for the invention includes monomers having a positive charge such as ammonium and phosphonium, and monomers having a negative charge such as sulfonate group, carboxylate group, phosphate group and phosphonate groups or having an acidic group capable of dissociating to a negative charge, as well as monomers having a polar group (hydrophilic group) having a nonionic group for example, hydroxyl group, amido group, sulfoneamide group, alkoxy group, and cyano group can also be used.

Specific examples of the monomer having the polar group (hydrophilic group) particularly useful in the invention can include the following monomers. For example, (meth)acrylic acid or alkali metal salts and amine salts thereof, itaconic acid or alkali metal salts and amine acid salts thereof, alkylamines or hydrohalogenic acid salts thereof, 3-vinyl propionic acid or alkali metal salts and amine salts thereof, vinyl sulfonic acid or alkali metal salts and amine salts thereof, styrene sulfonic acid or alkali metal salts and amine salts thereof, 2-sulfoethylene(meth)acrylate, 3-sulfopropylene(meth)acrylate or alkali metal salts and amine salts thereof, 2-acrylamide-2-methylpropane sulfonic acid or alkali metal salts and amine salts thereof, acid phosphoxypolyoxyethylene glycol mono(meth)acrylate or salts thereof, 2-dimethylaminoethyl(meth)acrylate or hydrohalogenic acid salts thereof, 3-trimethylammonium propyl(meth)acrylate, 3-trimethyl ammonium propyl(meth)acrylamide, and N,N,N-trimethyl-N-(2-hydroxy-3-methacryloyloxypropyl)ammonium chloride can be used. Further, 2-hydroxyethyl(meth)acrylate, (meth)acrylamide, N-monomethylol(meth)acrylamide, N-dimethylol(meth)acrylamide, N-vinylpyrrolidone, N-vinylacetoamide, polyoxyethylene glycol mono(meth)acrylate are also useful.

The macromer having a polar group (hydrophilic group) useful in the invention can be obtained by the synthesis method described in “New Polymer Experimental Science 2, Synthesis and Reaction of Polymer” edited by the Society of Polymer Science Japan, published from Kyoritsu Shuppan Co. in 1995. Further, it is specifically described also in “Chemistry and Industry of Macromonomer” written by Y. Yamashita, et. al., I.P.C. 1989.

Specifically, macromers having the polar group can be synthesized in accordance with the methods described in the literatures by using monomers having the polar group (hydrophilic group) described specifically above such as acrylic acid, acrylamide, 2-acrylamide-2-methylpropane sulfonic acid, and N-vinylacetoamide.

Among the macromers having the polar group (hydrophilic group) used in the invention, particularly useful are macromers derived from carboxylic group-containing monomers such as acrylic acid and methacrylic acid, solfonic acid type macromers derived from monomers of 2-acrylamide-2-methylpropane sulfonic acid, styrene sulfonic acid, and salts thereof, amide type macromers such as acrylamide and methacryl amide, amide type macromers derived from N-vinyl carboxylic acid amide monomers such as N-vinyl acetoamide and N-vinyl formamide, macromers derived from hydroxyl group-containing monomers such as hydrxyethylmethacrylate, hydroxyethyl acrylate, and glycerol monomethacrylate, and macromers derived from monomers containing alkoxy group or ethylene oxide group such as methoxyethyl acrylate, methoxypolyethylene glycol acrylate, and polyethylene glycol acrylate. Further, monomers having polyethylene glycol chains or polypropylene glycol chains can also be used usefully as the macromer of the invention.

Among them, macromers having the amide group as the polar group are used preferably with a view point that the polarity interaction with the sol-gel crosslinked structure formed in the process of forming the organic-inorganic composite layer to be described later is formed strongly.

The useful molecular weight for the macromers is within a range from 400 to 100,000, preferably, within a range from 1,000 to 50,000 and, particular preferably, within a range from 1,500 to 20,000.

Further, the graft polymer chain in the invention preferably has an alkoxide group of the element selected from the group consisting of Si, Ti, Zr, and Al (hereinafter sometimes referred to as an alkoxide group of a specific element) as described previously. The alkoxide group of the specific element is a substituent capable of forming a covalent bond by way of hydrolysis and polycondensating reaction with a crosslinker (metal alkoxide) to be described later. When the graft polymer chain has an alkoxide group of the specific element as described above, a covalent bond can be formed between the sol-gel crosslinked structure and the graft polymer chain formed in the process of forming the organic-inorganic composite layer to be described later.

In a case of using the surface graft polymerization method (1), a monomer or a macromer having an alkoxide group of a specific element is used preferably. Typical silane coupling group as the alkoxide group of the specific element are to be described specifically with reference to examples. As silane coupling groups suitable to the invention, functional groups as shown in the following formula (1) can be exemplified.

(R¹)ₘ(OR²)₃₋ₘ—Si— formula (1)

In the general formula (1), R¹ and R² each represents independently a hydrogen atom, or a hydrocarbon group of 8 or less carbon atoms and m represents an integer of 0 to 2.

The hydrocarbon group in a case where R¹ and R² each represents the hydrocarbon group includes alkyl groups and aryl groups, and linear, branched, or cyclic alkyl groups of 8 or less carbon atoms are preferred. Specifically, they include, for example, a methyl group, ethyl group, propyl group, butyl group, pentyl group, hexyl group, heptyl group, octyl group, isopropyl group, isobutyl group, s-butyl group, t-butyl group, isopentyl group, neopentyl group, 1-methylbutyl group, isohexyl group, 2-ethylhexyl group, 2-methylhexyl group, and cyclopentyl group.

R¹ and R² are preferably hydrogen atom, methyl group or ethyl group with a view point of effects and easy availability.

Monomers having the functional group as shown in the general formula (1) include, for example, (3-acryloxypropyl)trimethoxysilane, (3-acryloxypropyl)dimethylmethoxysilane, (3-acryloxypropyl)methyldimethoxysilane, (methacryloxymethyl)dimethylethoxysilane, (metharyloxymethyl)triethoxysilane, (methacryloxymethyl trimethoxysilane, (methacryloxypropyl)dimethylethoxysilane, (methacryloxypropyl)dimethylmethoxysilane, (methacryloxypropyl)methyldiethoxysilane, (methacryloxypropyl)triethoxysilane, (methacryloxypropyl)triisopropylsilane, and methacryloxypropyl(trismethoxyethoxy)silane.

In the invention, in a case of using the method (1), it is preferred to form a graft polymer chain by using a monomer or a macromer having a polar group and a monomer or a macromer having an alkoxide group of a specific element such as a silane coupling agent and copolymerizing them by a surface graft polymerization method. It is more preferred to use, among them, a monomer or a macromer having an amide group as the polar group.

Further, in a case of applying the organic-inorganic hybrid material to be produced to the superhydrophilic material, it is preferred to use a monomer or a macromer having a hydrophilic group as one of polar groups upon copolymerization.

(2) Method of Chemically Bonding a Polymer Having a Functional Group Reactive with a Support and the Surface of the Support to Form a Graft Polymer Chain

In the method, a graft polymer chain can be formed by using a polymer having a functional group reactive with a support at the terminal end of the main chain or on the side chains and chemically reacting the functional group and the functional group on the surface of the support. The functional group reactive with the support is not particularly restricted so long as it can react with the functional group on the surface of the support and can include, for example, a silane coupling group such as an alkoxy silane, isocyanate group, amino group, hydroxyl group, carboxyl group, sulfonic acid group, phosphonic acid group, epoxy group, allyl group, methacryloyl group, and acryloyl group.

The compound particularly useful as the polymer having the functional group reactive with the support on the main chain terminal or on the side chain is a polymer having a trialkoxy sillyl group on the polymer terminal end, a polymer having an amino group on the polymer terminal end, a polymer having a carboxyl group on the polymer terminal end, a polymer having an epoxy group on the polymer terminal end, and a polymer having an isocyanate group on the polymer terminal end.

Further, the polymer used in this method preferably has a polar group (hydrophilic group) further and the polymer having the polar group includes, specifically, polyacrylic acid, polymethacrylic acid, polystyrene sulfonic acid, poly-2-acrylamide-2-methylpropyane sulfonic acid and salts thereof, polyacrylamide, and polyvinyl acetoamide.

In addition, polymers of monomers having polar groups, or copolymers containing monomers having the polar groups used in the method (1) described can also be used.

A polymer having an amide group as the polar group is used preferably with a view point that a polarity interaction relative to the sol-gel crosslinked structure formed in the process of forming the organic-inorganic composite layer to be described later is formed strongly.

Further, in a case of applying the organic-inorganic hybrid material to be produced to a superhydrophilic material, it is preferred to use a polymer having a hydrophilic group as a sort of the polar groups and forming a graft polymer layer having hydrophilicity in the method (2).

On the other hand, the polymer having the functional group reactive with the support on the main chain terminal end or on the side chains preferably has an alkoxide group of an element selected from the group consisting of Si, Ti, Zr, and Al further (alkoxide group of a specific element). By the use of the polymer, the alkoxide group of the specific element can be introduced into the graft polymer chain to be formed. Since the graft polymer chain has an alkoxide group of the specific element, a covalent bond can be formed between the sol-gel crosslinked structure and the graft polymer chain formed in the process of forming the organic-inorganic composite layer to be described later.

In the invention, it is particularly preferred that the polymer having the functional group reactive with the support on the main chain terminal end or on the side chain has both of the amide group and the alkoxide group of the specific element as the polar group.

In the invention, the graft polymer chain formed by the method described above preferably has the amide group and/or the alkoxide group of the specific element with a view point of the forming property of the polar interaction with the sol-gel crosslinked structure and the forming property of the covalent bond.

A preferred introduction amount of the amide group in the graft polymer chain is within a range from 10 mol % to 90 mol % and the introduction amount of the alkoxide group of the specific element is preferably within a range from 10 mol % to 90 mol % in the invention.

The graft polymer chain in the invention preferably has the polar group (hydrophilic group) or the alkoxide group of the specific element described above in the chain and, in addition to the groups described above, a crosslinking group, polyerizable group or the like may be introduced and a crosslinked structure may be formed between the graft polymer chains by using such groups.

[Support]

As the support in the invention, a support of any shape can be used so long as it has a mechanical strength and dimensional stability and can be selected properly depending on the application use of the organic-inorganic hybrid material or superhydrophilic material.

In a case of using a film as the support, the film includes, specifically, polyester films such as polyethylene terephthalate film, polyethylene terephthalate type copolyester film, and polyethylene naphthalate film; polyamide films such as Nylon 66 film, Nylon 6 film, and metaxylidene copolyamide film; polyolefin films such as polypropylene film, polyethylene film, and ethylene-propylene copolymer film; polyimide film; polyamideimide film; polyvinyl alcohol film; ethylene-vinyl alcohol copolymer film; polyphenylene film, polysulfone film; and polyphenylene sulfide film. Among them, the polyester film such as polyethylene terephthalate film, and polyolefin film such as polyethylene film and polypropylene film are preferred with a view point of the cost performance. The films may be stretched or unscratched films and they may be used alone or films of different properties may be used in lamination.

In addition to them, supports made of glass, metal, ceramics, etc. may also be used.

Further, for the film used as the support, various additives or stabilizers may be incorporated or coated so long as they do not impair the effect of the invention. The additives usable herein include, for example, antioxidants, antistatics, UV-absorbents, plasticizers, lubricants, and heat stabilizers. Further, surface treatment such as corona treatment, plasma treatment, glow discharge treatment, ion bombardment treatment, medical treatment, solvent treatment, and a roughing treatment may be applied.

In a case where the support is a film, the thickness has no particular restriction since this can be determined properly while considering the adaptability to the purpose of use, and it is preferably within a range from 3 μm to 1 mm with a point of view for the general practical use and, more preferably, within a range from 10 to 300 μm with a view point of flexibility and fabricability.

Such a support may be used as it is so long as the support itself can generate active species by the application of energy but may have a surface layer having a polymerization initiation performance on the surface of the support with an aim of more efficiently generating the initiation species for forming the graft polymer chain.

The surface layer having the polymerization initiation performance is preferably a layer containing a low molecular or high molecular weight polymerization initiator. Among them, a polymerization initiation layer formed by fixing a polymerization initiator by crosslinking reaction is preferred with a view point of stability and durability, and a polymerization initiation layer formed by fixing a polymer having a functional group with a polymerization initiation function and a crosslinking group on the side chains by crosslinking reaction is more preferred.

The polymerization initiation layer formed by fixing the polymer having the functional group with the polymerization initiation performance and the crosslinking group on the side chain by crosslinking reaction is specifically described in JP-A No. 2004-161995 in columns [0011] to [0169], and the polymerization initiation layer can be applied to the invention.

### <Process of Forming Organic-Inorganic Composite Layer Having Protrusion and Depression Surface>

In this process, an organic-inorganic composite layer having a surface having protrusions and depressions is formed by providing fine inorganic particles with a volume average grain size of 1 μm or more in a graft polymer layer obtained by the graft polymer layer forming process described above, further conducting crosslinking reaction by hydrolysis and polycondensation of an alkoxide of an element selected from the group consisting of Si, Ti, Zr, and Al in the graft polymer layer.

In this process, a shape of protrusions and depressions is formed on the surface of the organic-inorganic composite layer formed by providing fine inorganic particles in a graft polymer layer and, further, forming a gel-sol crosslinked structure in the graft polymer layer.

As described above, the organic-inorganic composite layer in the invention is a layer in which an organic ingredient comprising the graft polymer chain and an inorganic ingredient comprising a crosslinked structure (sol-gel crosslinked structure) formed by conducting crosslinking reaction by hydrolysis and polycondensation of an alkoxide of an element selected from the group consisting of Si, Ti, Zr and Al, and fine inorganic particles are present in admixture.

At first, description is to be made to fine inorganic particles with a volume average grain size of 1 μm or more used in this process.

The fine inorganic particles include one or more of particles selected from the group consisting of oxides of one of silicon, tin, titanium, aluminum, zirconium, cerium and antimony, and carbon. Among them, silicon oxides are preferred and, particularly, colloidal silica is particularly preferred with a view point of the dispersion stability in a solution used upon provision to the graft polymer layer and easy availability of particles which are fine and relatively uniform for the grain size.

The volume average grain size of the fine inorganic particles described above should be 1 μm or more and is preferably 1.2 μm or more. Further, the upper limit value is preferably 5 μm with a view point of the durability of the surface having protrusions and depressions.

The volume average grain size of the fine inorganic particle can be measured by a laser diffraction/scattering type grain size measuring apparatus (LA-700, manufactured by Horiba Ltd.).

For the fine inorganic particles described above, a finely particular powder and a dispersion formed by dispersing commercially available fine inorganic particles can be used. Further, when a dispersion is prepared by dispersing the finely particulate powder in a solution, dispersing machines such as high speed rotary disperser, medium stirring type disperser (ball mill, and sand mill, etc.), supersonic disperser, colloid mill disperser, roll mill disperser, and high pressure disperser known so far can be used, and the supersonic disperser is preferred in that uniform and fine dispersion can be applied.

As a method of providing the fine inorganic particles into the graft polymer layer, a method of coating the liquid dispersion prepared as described above onto a graft polymer layer may be used. Further, for simplifying the production process, a method of adding fine inorganic particles to a coating solution composition containing a crosslinker to be described later and coating the composition to the graft polymer layer is used preferably.

The content of the fine inorganic particles in the liquid dispersion containing the fine inorganic particles may be controlled in accordance with the shape of protrusions and depressions formed on the surface of the organic-inorganic fine particles. Generally, it is preferably within a range from 5 to 70 mass %. A preferred range of the content is also identical with a case of adding the fine inorganic particles in the coating solution composition containing the crosslinker.

Further, in a case of forming the sol-gel crosslinked structure in the graft polymer layer in this process, it is preferred to use a compound capable of forming a crosslinked structure formed by conducting crosslinking reaction by hydrolysis and polycondensation of an alkoxide of an element selected from the group consisting of Si, Ti, Zr and Al (hereinafter sometimes simply referred to as “crosslinker”).

As the crosslinker in the invention, a compound, for example, represented by the following general formula (II) is used.

The compound represented by the following general formula (II) can form a covalent bond between a graft polymer chain and a sol-gel crosslinked structure in a case where the graft polymer chain has an alkoxide group of a specific element, by hydrolysis and polycondensation with the alkoxide group of the specific element. This can form a strong organic-inorganic composite layer.

(R⁶)ₘ—X—(OR⁷)₄₋ₘ formula (II)

In the formula (II), R⁶ represents a hydrogen atom, an alkyl group or aryl group, R⁷ represents an alkyl group or aryl group, X represents Si, Al, Ti or Zr, and m represents an integer of from 0 to 2.

In a case where R⁶ and R⁷ each represents the alkyl group, the number of carbon atoms thereof is preferably from 1 to 4. The alkyl group or aryl group may have a substituent and the substituent that can be introduced includes a halogen atom, amino group, mercapto group, etc.

The compound is a low molecular weight compound and the molecular weight is preferably 1,000 or less.

Specific examples of the compound represented by the formula (II) are to be described below but the invention is not restricted to them.

When X is Si, that is, when silicon is contained in the hydrolysable compound, specific examples of the crosslinking component include trimethoxysilane, triethoxysilane, tripropoxysilane, tetramethoxysilane, tetraethoxysilane, tetrapropoxysilane, methyltrimethoxysilane, ethyltriethoxysilane, propyltrimethoxysilane, methyltriethoxysilane, ethyltriethoxysilane, propyltriethoxysilane, dimethyldimethoxysilane, diethyldiethoxysilane, γ-chloropropyltriethoxysilane, γ-mercaptopropyltrimethoxysilane, γ-mercaptopropyltriethoxysilane, γ-aminopropyltriethoxysilane, phenyltrimethoxysilane, phenyltriethoxysilane, phenyltripropoxysilane, diphenyldimethoxysilane and diphenyldiethoxysilane.

Among these examples, particularly preferred examples are tetramethoxysilane, tetraethoxysilane, methyltrimethoxysilane, ethyltrimethoxysilane, methyltriethoxysilane, ethyltriethoxysilane, dimethyldiethoxysilane, phenyltrimethoxysilane, phenyltriethoxysilane, diphenyldimethoxysilane, diphenyldiethoxysilane, and so on.

Further, when X is Al, that is, those containing aluminum in the hydrolyzable compounds include, for example, trimethoxyaluminate, triethoxyaluminate, tripropoxyaluminate, and tetraethoxyaluminate.

When X is Ti, that is, those containing titanium include, for example, trimethoxytitanate, tetramethoxytitanate, triethoxytitanate, tetraethoxytitanate, tetrapropoxytitanate, chlorotrimethoxytitanate, chlorotriethoxytitanate, ethyltrimethoxytitanate, methyltriethoxytitanate, ethyltriethoxytitanate, diethyldiethoxytitanate, phenyltrimethoxytitanate, and phenyltriethoxytitanate.

When X is Zr, that is, those containing zirconium include, for example, zirconates corresponding to the compound exemplified as above as those containing titanium.

For forming a sol-gel crosslinked structure in the graft polymer layer by using such a crosslinker, a method of dissolving the crosslinker in a solvent such as ethanol, then optionally adding a catalyst or the like to prepare a coating solution composition and coating, heating and drying the composition on the graft polymer layer can be used. By the hydrolysis and polycondensation of the crosslinker by the method, the sol-gel crosslinked structure is formed.

As described above, the coating solution composition may also contain fine inorganic particles or inorganic material and by using such a coating solution composition, provision of the fine inorganic particles and the inorganic material and the provision of the crosslinker to the graft polymer layer may be conducted simultaneously.

The heating temperature and heating time are not restricted particularly so long as the solvent in the coating solution is removed and a strong film is formed by the temperature and the time. However, with a view point of production adaptability, etc., the heating temperature is preferably 200° C. or lower and the heating time (crosslinking time) is preferably within 1 hr.

The content of the crosslinker in the coating solution composition may be determined in accordance with the amount of the sol-gel crosslinked structure to be formed and generally it is preferably within a range from 5 to 50 mass % and, more preferably, within a range from 10 to 40 mass % with a view point of the surface hardness of the organic-inorganic composite layer to be formed and the adhesion thereof to the support.

Further, in a case where the graft polymer chain has an alkoxide group of the specific element in the chain, the content of the crosslinker in the coating solution composition is preferably controlled to such an amount that the crosslinking group in the crosslinker is 5 mol % or more and, further, 10 mol % or more in the crosslinker based on the alkoxide group of the specific element.

In this case, the upper limit for the content of the crosslinker is not particularly restricted so long as it is within a range capable of sufficiently crosslinking with the alkoxide group of the specific element. In a case of addition in great excess, it may possibly cause a sticking problem to the formed organic-inorganic composite layer due to the crosslinker not relevant to crosslinking.

The solvent used for preparation of the coating solution composition has no particular restriction so long as it can uniformly dissolve and disperse the crosslinker and other ingredients and, for example, an aqueous solvent such as of methanol, ethanol or water is preferred.

Further, for the coating solution composition, an acidic catalyst or a basic catalyst is preferably used in combination for promoting the hydrolysis and polycondensating reaction of the crosslinker and the catalyst is essential in a case of intending to obtain a practically preferred reaction efficiency.

As a catalyst, an acid or basic compound can be used as it is, or it can be used in a state being dissolved in a solvent such as water or alcohol (hereinafter referred to as acid catalyst and basic catalyst respectively). The concentration of the catalyst when dissolved in a solvent is not particularly restricted and may be selected properly depending on the property of the acidic or basic compound, a desired content of the catalyst, etc. In a case where the concentration is high, the hydrolysis and polycondensation rate tend to be higher. However, in a case of using a basic catalyst at a high concentration, since precipitates are sometimes formed in the coating solution composition, the concentration of the basic catalyst when it is used is desirably 1N or less based on a concentration in an aqueous solution.

While the kind of the acidic catalyst or the basic catalyst is not particularly restricted, in a case where it is necessary to use a catalyst at a high concentration, a catalyst consisting of an element that scarcely remains in the coating after drying is preferred.

Specifically, the acidic catalyst includes hydrogen halides such as hydrochloric acid, nitric acid, sulfuric acid, sulfurous acid, hydrogen sulfide, perchloric acid, hydrogen peroxide, carbonic acid, carboxylic acid such as formic acid or acetic acid, substituted carboxylic acid formed by substituting R in the structural formula thereof represented by RCOOH with other element or a substituent, and sulfonic acid such as benzene sulfonic acid. The basic catalyst includes an ammonic base (such as aqueous ammonia) and amine such as ethylamines or aniline.

For the coating solution composition, various additives can be used according to the purpose so long as they do not impair the effect of the invention. For example, a surfactant, etc. can be added for improving the uniformity of the coating solution.

In the invention, the graft polymer layer and an organic-inorganic composite layer may also be formed by the following method.

For example, a method of preparing a coating solution composition containing a polymer having a functional group reactive with a support on the main chain terminal end or on the side chain in addition to the polar group and the alkoxide group of the specific element, a crosslinker, fine inorganic particles and a catalyst, coating the composition on a support on which radicals as the active species are generated on the surface by the treatment with plasmas or electron beams and heating and drying the same can be mentioned.

In this method, since the functional group of the polymer reactive with the support and the support are reacted, a graft polymer coupled directly to the support is formed, and the graft polymer layer is formed. Further, upon heating and drying the coating solution composition, hydrolysis and polycondensating reaction of the crosslinker are taken place and the crosslinked structure can be formed in the graft polymer layer.

That is, according to the method described above, the graft polymer layer and the organic-inorganic composite layer can be formed all at once by a series of process of preparing the coating solution composition and coating, heating and drying the same.

Upon preparation of the coating solution composition, a hydrophilic polymer may also be contained additionally. The hydrophilic polymer can include, for example, polyvinyl alcohol, and it can be obtained by polymerization of a monomer having a polar group useful for forming the graft polymer chain descried previously. The content of the hydrophilic polymer is preferably 10 mass % or more and less than 50 mass % based on the solid content. In a case where the content is more than 50 mass %, the film strength tends to be lowered and, in a case where it is less than 10 mass %, the film property is deteriorated to possibly cause cracking to the film, and both of the cases are not preferred.

As has been described above, formation of the organic-inorganic composite layer in the invention utilizes the sol-gel method. The sol-gel method is described specifically in standard books such as “Science of Sol-Gel Method”, written by Sumio Sakuhana published from Agne Shohusha (1988), “Newest Functional Thin Film Preparation Technique by Modern Sol-Gel method”, written by Suzuri Hirashima published from Sogo Technical Center (1992) and the method described in them can be applied to the formation of the organic-inorganic composite layer in the invention.

The film thickness of the organic-inorganic composite layer can be selected depending on the application use, etc. of the organic-inorganic hybrid material and, generally, it is preferably within a range from 0.1 μm to 10 μm and, more preferably, within a range from 0.5 μm to 10 μm. Since sufficient strength and wear resistance can be obtained within the range of the film thickness, and occurrence of curl, deterioration of flexibility or flexing resistance are less caused, the range is preferred.

Further, in a case of applying the organic-inorganic hybrid material of the invention to the superhydrophilic material, preferred wetting property and durability and retainability thereof can be obtained by defining the thickness of the organic-inorganic composite layer to the range described above.

As has been described above, in the method for producing the organic-inorganic hybrid material of the invention, a protrusion and depression shape is formed on the surface of the organic-inorganic composite layer by using fine inorganic particles, but the protrusion and depression shape may also be formed without using fine inorganic particles to prepare an organic-inorganic hybrid material of the invention.

For example, it is possible to form an organic-inorganic composite layer having a surface having protrusions and depressions and the organic-inorganic hybrid material of the invention can be produced by controlling the condition upon forming the sol-gel crosslinked structure in the graft polymer layer.

As has been described above, in the invention, the organic-inorganic composite layer comprises a graft polymer chain formed by direct bonded to the surface of the support and a sol-gel crosslinked structure formed in the graft polymer layer comprising the graft polymer chain, and further has a protrusion and depression surface. The organic-inorganic hybrid material of the invention having the organic-inorganic composite layer described above is excellent in the adhesion between the protrusion and depression surface of the organic-inorganic composite layer and the support.

Accordingly, in a case of applying the organic-inorganic hybrid material to the superhydrophilic material, it has the superhydrophilicity and is excellent in the retainability thereof.

### EXAMPLE

The present invention is to be described specifically with reference to examples but the invention is not restricted to them.

### Example 1

### <Support>

A biaxially stretched polyethylene terephthalate film of 188 μm thickness (A4100, manufactured by Toyobo Co.) was used, and a PET support was obtained by applying an oxygen glow treatment under the following conditions using a plate Magnetron Sputtering Apparatus (CFS-10-EP70, manufactured by Shibaura Eletex Co.) as a glow treatment apparatus.

### —Oxygen Glow Treatment Condition—

Initial vacuum: 1.2×10⁻³ Pa
Oxygen pressure: 0.9 Pa

### RF Glow: 1.5 kW

### Treating Time: 60 sec

### <Graft Polymer Layer Formation 1>

Then, a mixed solution of N,N-dimethylacrylamide, methacryloxypropyl triethoxysilane, and ethanol (N,N-dimethylacrylamide: methacryloxy propyltriethoxy silane=1:1 (molar ratio), concentration: 50 mass %) was subjected to nitrogen bubbling. The PET support described above was dipped at 70° C. for 7 hours in the mixed solution. The PET support after dipping was cleaned sufficiently with ethanol to form a graft polymer layer in which the graft polymer chain having the silane coupling group as the alkoxide group of specific element and the amide group are bonded directly to the surface of the support in the structure. The PET support having the graft polymer layer was defined as a support A.

### <Formation of Organic-Inorganic Composite Layer Having Protrusion and Depression Surface 1>

A coating solution composition 1 containing ethanol, water, tetraethoxysilane, phosphoric acid, collidal silica, and polyvinyl alcohol each in the following amount and stirred at a room temperature for 24 hours was coated on the obtained support A, and dried by heating at 100° C. for 10 min and an organic-inorganic composite layer was formed to obtain an organic-inorganic hybrid material A. The thickness of the organic-inorganic composite layer formed in this case was 2.4 μm.

### —Coating Solution Composition 1—

| | |
|---|---|
| Tetraethoxysilane (crosslinker) | 0.9 g |
| Ethanol | 3.7 g |
| Water | 8.7 g |
| Aqueous phosphoric acid solution (0.85% aqueous solution) | 1.3 g |
| Colloidal Silica (volume average grain size: 1.4 μm) | 0.36 g |
| Aqueous polyvinyl alcohol solution (95% saponification, | 3.0 g |
| 10 mass % aqueous solution) | |

### Example 2

An organic-inorganic hybrid material B was obtained in the same method as in Example 1 except for replacing 0.9 g of tetraethoxysilane contained in the coating solution composition 1 used for the formation of the organic-inorganic composite layer in <formation of organic-inorganic composite layer 1> in Example 1 to 1.0 g of tetramethoxytitanate. The thickness of the organic-inorganic composite layer in the organic-inorganic hybrid material B was 3.2 μm.

### Example 3

An organic-inorganic hybrid material C was obtained in the same method as in Example 1 except for replacing 0.9 g of tetraethoxysilane contained in the coating solution composition 1 used for the formation of the organic-inorganic composite layer in <formation of organic-inorganic composite layer 1> in Example 1 to 1.6 g of tetramethoxyzirconate. The thickness of the organic-inorganic composite layer in the organic-inorganic hybrid material C was 2.8 μm.

### Example 4

An organic-inorganic hybrid material D was obtained in the same method as in Example 1 except for replacing 0.9 g of tetraethoxysilane contained in the coating solution composition 1 used for the formation of the organic-inorganic composite layer in <formation of organic-inorganic composite layer 1> in Example 1 to 0.7 g of trimethoxyaluminate. The thickness of the organic-inorganic composite layer in the organic-inorganic hybrid material D was 3.0 μm.

### Example 5

An organic-inorganic hybrid material E was obtained in the same manner as in Example 1 except for preparing a support B by changing <formation of graft polymer layer 1> in Example 1 to the following <formation of graft polymer layer 2> to prepare a support B and, further, changing the support A used in the <Formation of organic-inorganic composite layer 1> to the substrate B to prepare an organic-inorganic hybrid film B.

### <Formation of Graft Polymer Layer 2>

An aqueous acrylamide solution (concentration: 50 mass %) was subjected to nitrogen bubbling. The PET support used in Example 1 was dipped in the aqueous solution at 70° C. for 7 hours. The PET support after dipping was sufficiently cleaned with distilled water to form a graft polymer layer in which the graft polymer chain having the amide group in the structure was directly bonded to the surface of the support. The PET support having the graft polymer layer was defined as a support B.

### Example 6

### <Formation of Graft Polymer Layer 3>

A solution of methacryloxy propyl triethoxysilane•ethanol (concentration: 50 mass %) was subjected to nitrogen bubbling. The PET support used in Example 1 was dipped in the solution at 70° C. for 7 hours. The PET support after dipping was sufficiently cleaned with distilled water to form a graft polymer layer in which the graft polymer chain having the silane coupling group as the alkoxide group of specific element in the structure was directly bonded to the surface of the support. The PET support having the graft polymer layer was defined as a support C.

### <Formation of Organic-Inorganic Composite Layer 2>

A coating solution composition 2 containing ethanol, water, tetraethoxysilane, phosphoric acid, and colloidal silica, each in the following amount and stirred at a room temperature for 5 hours was coated on the obtained support C, and dried by heating at 100° C. for 10 min and an organic-inorganic composite layer was formed to obtain an organic-inorganic hybrid F. The thickness of the organic-inorganic composite layer herein was 2.9 μm.

### —Coating Solution Composition 2—

| | |
|---|---|
| Ethanol | 10.5 g |
| Tetraethoxysilane (crosslinker) | 3.5 g |
| Water | 1.0 g |
| Aqueous phosphoric acid solution (aqueous 0.85% solution) | 1.0 g |
| Colloidal Silica (volume average grain size: 1.4 μm) | 0.30 g |

### Comparative Example 1

An organic-inorganic hybrid material G was obtained in the same method as Example 1 except for changing the support (PET support having the graft polymer layer) A used in Example 1 to polyethylene terephthalate.

[Evaluation for the Performance of Organic-Inorganic Hybrid Material]

For the organic-inorganic hybrid materials A-G of Examples 1 to 6 and Comparative Examples 1, the performance was evaluated as below. The results are shown in the following Table 1.

### 1. Measurement for Surface Shape

The specific surface area ratio, the alithmetic average roughness Ra (nm), and the height for the protrusion portion (maximum difference for height P−V) of the organic-inorganic hybrid materials A to G were measured by a simple AFM (nanopics, manufactured by Seiko Instruments Co.). The obtained results are shown in Table 1.

### 2. Evaluation for Superhydrophilicity

After dripping pure water to the surface of the organic-inorganic hybrid materials A to G, angles were measured 20 sec after by using CA-Z manufactured by Kyowa Interface Science Co. Ltd. and materials having contact angle with water droplets of 5° or less were indicated as “Good”. The results are shown in Table 1.

### 3. Evaluation for Adhesion

Cross cuts each of 1 mm square were applied by the number of 100 to the surface of organic-inorganic hybrid materials A to G by using a rotary cutter and after press-bonding a Sellotape (registered trade mark of Nichiban Co.), a 90° peal test at 30,000 mm/min was practized by three times according to JIS K5400. Evaluation was made by measuring the number of cross cuts left after the peel test. The results are shown in Table 0.1

TABLE 1

| | | Surface shape of | | | | |
|---|---|---|---|---|---|---|
| | | organic-inorganic | | | | |
| | | composite layer | | | | |
| | | | Specific | Height of | | |
| | | | surface | protrusion | | |
| | Organic-inorganic | Ra | area | portion | Super- | |
| | Hybrid material | (nm) | ratio | (μm) | hydrophilicity | Adhesion |
| Example 1 | Organic-inorganic | 229 | 1.29 | 2.02 | good | 100/100 |
| | hybrid material A | | | | | |
| Example 2 | Organic-inorganic | 277 | 1.21 | 2.15 | good | 100/100 |
| | hybrid material B | | | | | |
| Example 3 | Organic-inorganic | 277 | 1.25 | 3.70 | good | 100/100 |
| | hybrid material C | | | | | |
| Example 4 | Organic-inorganic | 406 | 1.35 | 2.83 | good | 100/100 |
| | hybrid material D | | | | | |
| Example 5 | Organic-inorganic | 282 | 1.26 | 3.45 | good | 98/100 |
| | hybrid material E | | | | | |
| Example 6 | Organic-inorganic | 377 | 1.26 | 3.10 | good | 100/100 |
| | hybrid material F | | | | | |
| Comparative | Organic-inorganic | 320 | 1.30 | 2.82 | good | 5/100 |
| Example 1 | hybrid material G | | | | | |

From the result of Table 1, it can be seen that the organic-inorganic hybrid materials A to F of the examples having the organic-inorganic composite layer have preferred protrusion and depression surface shape, and superhydrophilicity, and the adhesion between the support and the protrusion and depression surface is preferred.

Thus, it can be seen that the organic-inorganic hybrid materials A to F of the examples are suitable to the superhydrophilic materials having the superhydrophilicity and retainability thereof.

The invention intends to provide an organic-inorganic hybrid material having a surface having protrusions and depressions excellent in the adhesion to a support, as well as a production method therefore.

Further, according to the invention, a superhydrophilic material having the superhydrophilicity and retainability thereof can be provided by using the organic-inorganic hybrid material of the invention.

The invention also includes the following embodiments.

<1> An organic-inorganic hybrid material including a support, and an organic-inorganic composite layer containing a crosslinked structure formed by hydrolysis and polycondensation of an alkoxide of an element selected from the group consisting of Si, Ti, Zr, and Al in a graft polymer layer comprising a graft polymer chain bonded directly to the surface of the support, and having a surface having protrusions and depressions.

### <2> An organic-inorganic hybrid material according to item <1>, wherein the arithmetic average roughness (Ra) on the surface having protrusions and depressions is 0.03 μm or more.

### <3> An organic-inorganic hybrid material according to item <2>, wherein the arithmetic average roughness (Ra) on the surface having protrusions and depressions is from 0.03 μm to 1.0 μm.

### <4> An organic-inorganic hybrid material according to any one of items <1> to <3>, wherein the specific surface area ratio on the surface having protrusions and depressions is 1.2 or more.

### <5> An organic-inorganic hybrid material according to item <4>, wherein the specific surface area ratio on the surface having protrusions and depressions is from 1.2 to 2.0.

### <6> An organic-inorganic hybrid material according to any one of items <1> to <5>, wherein the height for the protrusion portion on the surface having protrusions and depressions is from 0.1 to 5 μm.

### <7> An organic-inorganic hybrid material according to item <6>, wherein the height for the protrusion portion on the surface having protrusions and depressions is from 0.1 to 4 μm.

### <8> An organic-inorganic hybrid material according to claim 1, wherein the graft polymer chain has an alkoxide group of an element selected from the group consisting of Si, Ti, Zr, and Al in the chain.

### <9> An organic-inorganic hybrid material according to claim 8, wherein the alkoxide group is represented by formula (1):

(R¹)ₘ(OR²)₃₋ₘ—Si— Formula (1)

wherein in formula (1), R¹ and R² each represents independently a hydrogen atom, or a hydrocarbon group of 8 or less carbon atoms and m represents an integer of 0 to 2.

### <10> An organic-inorganic hybrid material according to item <1>, wherein the graft polymer chain has an amide group in the chain.

### <11> An organic-inorganic hybrid material according to <1>, wherein the graft polymer layer comprising a graft polymer contains a compound capable of forming a crosslinked structure.

### <12> An organic-inorganic hybrid material according to claim, wherein the compound capable of forming a crosslinked structure is represented by formula (2):

(R⁶)ₘ—X—(OR⁷)₄₋ₘ Formula (2)

wherein in formula (II), R⁶ represents a hydrogen atom, an alkyl group or aryl group, R⁷ represents an alkyl group or aryl group, X represents Si, Al, Ti or Zr, and m represents an integer of from 0 to 2.
<13.> A method for producing an organic-inorganic hybrid material comprising:

forming a graft polymer chain directly bonded to the surface of a support and forming a graft polymer layer comprising the graft polymer chain, and

providing fine inorganic particles with a volume average grain size of 1 μm or more in the graft polymer layer and further conducting a crosslinking reaction in the graft polymer by hydrolysis and polycondensation of an alkoxide of an element selected from the group consisting of Si, Ti, Zr and Al in the graft polymer layer, thereby forming an organic-inorganic composite layer having a surface having protrusions and depressions.

### <14> The method for producing an organic-inorganic hybrid material of item <13>, wherein a volume average grain size of the fine inorganic particles is from 1 μm to 5 μm.

<15> The method for producing an organic-inorganic hybrid material of item <13>, wherein the fine inorganic particles are one or more of particles selected from the group consisting of oxides of one of silicon, tin, titanium, aluminum, zirconium, cerium and antimony, and carbon.

### <16> A superhydrophilic material comprising the organic-inorganic hybrid material according to any one of items <1> to <12>.

All publications, patent applications, and technical standards mentioned in this specification are herein incorporated by reference to the same extent as if such individual publication, patent application, or technical standard was specifically and individually indicated to be incorporated by reference.

It will be obvious to those having skill in the art that many changes may be made in the above-described details of the preferred embodiments of the present invention. The scope of the invention, therefore, should be determined by the following claims.

What is claimed is:

1. An organic-inorganic hybrid material comprising a support, and an organic-inorganic composite layer having a surface having protrusions and depressions a containing a crosslinked structure formed by hydrolysis and polycondensation of an alkoxide of an element selected from the group consisting of Si, Ti, Zr, and Al, the organic-inorganic composite layer being provided within a graft polymer layer comprising a graft polymer chain that is bonded directly to a surface of the support.

2. The organic-inorganic hybrid material according to claim 1, wherein an arithmetic average roughness (Ra) on the surface having protrusions and depressions is 0.03 μm or more.

3. The organic-inorganic hybrid material according to claim 2, wherein the arithmetic average roughness (Ra) on the surface having protrusions and depressions is from 0.03 μm to 1.0 μm.

4. The organic-inorganic hybrid material according to claim 1, wherein a specific surface area ratio on the surface having protrusions and depressions is 1.2 or more.

5. The organic-inorganic hybrid material according to claim 4, wherein the specific surface area ratio on the surface having protrusions and depressions is from 1.2 to 2.0.

6. The organic-inorganic hybrid material according to claim 1, wherein the height of protruding portions on the protrusion and depression surface is from 0.1 to 5 μm.

7. The organic-inorganic hybrid material according to claim 6, wherein the height of the protruding portions on the protrusion and depression surface is from 0.1 to 4 μm.

8. The organic-inorganic hybrid material according to claim 1, wherein the graft polymer chain has an alkoxide group of an element selected from the group consisting of Si, Ti, Zr, and Al in the chain.

9. The organic-inorganic hybrid material according to claim 8, wherein the alkoxide group is represented by the following formula (1):
(R¹)ₘ(OR²)₃₋ₘ—Si— Formula (I)
wherein in formula (1), R¹ and R² each independently represents a hydrogen atom or a hydrocarbon group of 8 or less carbon atoms, and m represents an integer of 0 to 2.

10. The organic-inorganic hybrid material according to claim 1, wherein the graft polymer chain has an amide group in the chain.

11. The organic-inorganic hybrid material according to claim 1, wherein the graft polymer layer comprises a compound capable of forming a crosslinked structure.

12. The organic-inorganic hybrid material according to claim 11, wherein the compound capable of forming a crosslinked structure is represented by the following formula (II):
(R⁶)ₘ—X—(OR⁷)₄₋ₘ Formula (II)
wherein in formula (II), R⁶ represents a hydrogen atom, an alkyl group or aryl group, R⁷ represents an alkyl group or aryl group, X represents Si, Al, Ti or Zr, and m represents an integer of from 0 to 2.

13. A method for producing an organic-inorganic hybrid material comprising:
forming a graft polymer chain directly bonded to the surface of a support and forming a graft polymer layer comprising the graft polymer chain, and
providing fine inorganic particles with a volume average grain size of 1 μm or more in the graft polymer layer and further conducting a crosslinking reaction in the graft polymer layer by hydrolysis and polycondensation of an alkoxide of an element selected from the group consisting of Si, Ti, Zr and Al, thereby forming an organic-inorganic composite layer having an irregular surface.

14. The method for producing an organic-inorganic hybrid material according to claim 13, wherein a volume average grain size of the fine inorganic particles is from 0.1 μm to 5 μm.

15. The method for producing an organic-inorganic hybrid material according to claim 13, wherein the fine inorganic particles are one or more kind of particles selected from the group consisting of oxides of one of silicon, tin, titanium, aluminum, zirconium, cerium and antimony, and carbon.

16. A superhydrophilic material comprising the organic-inorganic hybrid material according to claim 1.

17. A superhydrophilic material comprising the organic-inorganic hybrid material according to claim 2.

18. A superhydrophilic material comprising the organic-inorganic hybrid material according to claim 4.

19. A superhydrophilic material comprising the organic-inorganic hybrid material according to claim 6.
